(19) United States
(12) Patent Application Publication
(10) Pub. No.: US 2023/0177479 A1
(43) Pub. Date: Jun. 8, 2023

(54) TRANSACTION SYSTEM, TRANSACTION METHOD, DEVICE, AND PROGRAM

(71) Applicant: Glory Ltd., Himeji (JP)

(72) Inventor: Hiroshi YAMAGUCHI, Himeji (JP)

(73) Assignee: Glory Ltd., Himeji (JP)

(21) Appl. No.: 18/165,953

(22) Filed: Feb. 8, 2023

Related U.S. Application Data
(63) Continuation of application No. PCT/JP2021/028814, filed on Aug. 3, 2021.

(30) Foreign Application Priority Data
Aug. 12, 2020 (JP) 2020-136441

(51) Int. Cl. G06Q 20/10; G06Q 20/40

(52) U.S. Cl. CPC G06Q 20/108; G06Q 20/4014

(57) ABSTRACT

A transaction system executing transaction processing with a customer by cooperation of a first terminal disposed in a sales office of a financial institution and a second terminal disposed in a location different from the sales office transmits data related to a transaction from the first terminal to the second terminal by communication, and the system includes a providing circuitry that provides a time stamp to at least part of the data related to the transaction transmitted from the first terminal before the second terminal starts transaction processing.

### CROSS-REFERENCE TO RELATED APPLICATIONS

This application is a bypass continuation of International Patent Cooperation Treaty Application No. PCT/JP2021/028814, filed on Aug. 3, 2021, and claims priority to Japanese Patent Application No. 2020-136441, filed on Aug. 12, 2020, the entire disclosures of each are incorporated herein by reference.

### TECHNICAL FIELD

The present disclosure relates to a transaction system, a transaction method, a device, and a program.

### BACKGROUND ART

Today, in the financial industry, there is a need to promote paperless and reduce the clerical burdens on a sales office.

### SUMMARY

A transaction system of the present disclosure is a transaction system executing a transaction with a customer by cooperation of a first terminal disposed in a sales office of a financial institution and a second terminal disposed in a location different from the sales office. The first terminal executes first processing related to the transaction and transmits data related to the transaction to the second terminal by communication. The second terminal executes second processing related to the transaction. The transaction system includes a providing circuitry that provides a time stamp to at least part of the data related to the transaction before the second processing is started.

### ADVANTAGEOUS EFFECTS

According to the present disclosure, it is possible to improve security in a transaction.

### BRIEF DESCRIPTION OF DRAWINGS

FIG. 1 is a diagram illustrating an example of a medium transaction system;

FIG. 2 is a diagram illustrating a configuration example of a sales office system;

FIG. 3 is a diagram illustrating a configuration example of a center system;

FIG. 4 is a diagram illustrating a configuration example of a transaction management server;

FIG. 5 is a diagram illustrating an example of processing operations in the case where cash withdrawal processing is executed in the medium transaction system;

FIG. 6 is a diagram illustrating an example of processing operations in the case where cash deposit processing is executed in the medium transaction system;

FIG. 7 is a diagram illustrating an example of a medium transaction system;

FIG. 8 is a diagram illustrating a configuration example of a customer DB server;

FIG. 9 is a diagram illustrating an example of processing operations in the case where the cash withdrawal processing and the cash deposit processing are executed in the medium transaction system;

FIG. 10 is a diagram illustrating an example of a medium transaction system;

FIG. 11 is a diagram illustrating an example of processing operations in the case where the cash withdrawal processing or the cash deposit processing are executed in the medium transaction system;

FIG. 12 is a diagram illustrating an example of a medium transaction system;

FIG. 13 is a diagram illustrating an example of processing operations in the case where cash withdrawal processing is executed in the medium transaction system;

FIG. 14 is a diagram illustrating an example of processing operations in the case where cash deposit processing is executed in the medium transaction system;

FIG. 15 is a diagram illustrating an example of a medium transaction system;

FIG. 16 is a diagram illustrating a configuration example of a sales office system; and

FIG. 17 is a diagram illustrating an example of processing operations in the case where the cash withdrawal processing or the cash deposit processing is executed in the medium transaction system.

### DESCRIPTION OF EMBODIMENTS

In the present specification, the term “money” is used to collectively refer to banknotes and coins, and the terms “banknotes” and “coins” are used individually in the case where it is required to distinguish therebetween. Note that, in the present specification, money delivered to and from a customer in a transaction is referred to as “cash.” In the present specification, a “medium” includes money, a check, a gift certificate, and a ticket. The transaction includes a transaction through the customer's account. The transaction through the account is sometimes described as an account transaction. The transaction through the account includes, for example, a deposit transaction to the account and a withdrawal transaction from the account. Transaction processing includes acceptance processing as the first processing and account processing as the second processing. The acceptance processing is the processing to accept slip data of a transaction. The account processing is processing related to an account, and includes identification of the account and confirmation of the account balance. The accounting process may include authentication processing of the customer. The transaction processing may include medium processing. The medium processing is the processing on a medium delivered to and from the customer. The medium processing includes deposit processing to receive money or checks from a customer, or withdrawal processing to deliver money or tickets to a customer. Hereinafter, exemplary embodiments will be described in detail with reference to attached drawings.

In the conventional technique, measures for verifying the cause are insufficient in the case where a contradiction occurs between details recognized on the sales office side of the financial institution and details carried out by an operator on the center side. In other words, there is a problem in security.

An object of the present disclosure is to improve security of a transaction system in which an operator in a remote location carries out work related to a transaction required by a customer who visits a sales office of a financial institution.

A transaction system of the present disclosure is a transaction system executing a transaction with a customer by cooperation of a first terminal disposed in a sales office of a financial institution and a second terminal disposed in a location different from the sales office. The first terminal executes first processing related to the transaction and transmits data related to the transaction to the second terminal by communication. The second terminal executes second processing related to the transaction. The transaction system includes a providing circuitry that provides a time stamp to at least part of the data related to the transaction before the second processing is started.

The transaction may be a transaction through the customer's account.

The first terminal may be disposed in each of the plural sales offices, and each of the first terminals may cooperate with the second terminal.

The plural second terminals may be disposed, and each of the plural second terminals may cooperate with the first terminal.

The first processing may be processing that does not involve communication with an accounting system. The accounting system is a system that manages customer's accounts.

The second processing may be processing that involves communication with the accounting system.

The transaction may be a transaction that involves identity verification.

The data related to the transaction may be slip data.

An execution record of the second processing may be linked to the data related to the transaction, to which the time stamp has been provided.

The transaction system may include a medium processing device disposed in the sales office to execute medium processing. The medium processing may include at least one of taking-in processing and paying-out processing of a medium related to the transaction. The medium processing device may communicate with the second terminal along with execution of the medium processing. The medium includes at least one of money, a check, a gift certificate, and a ticket.

The medium processing device may notify the second terminal of a result of the taking-in processing.

The medium processing device may execute the paying-out processing based on a notification of a result of the second processing from the second terminal. The notification may be a notification indicating completion of the second processing.

An execution record of the medium processing by the medium processing device may be linked to the data related to the transaction, to which the time stamp has been provided.

The transaction system may change an order of execution of the second processing based on a prescribed condition. Based on the prescribed condition, the first terminal may provide data, which indicates that the order of execution of the transaction processing in the second terminal needs to be changed, to the data related to the transaction. The prescribed condition may be a case in which an attribute of the customer satisfies a predetermined condition. The prescribed condition may be based on an attribute of another customer different from the customer. The prescribed condition may be based on a time stamp provided to data related to a transaction of the another customer.

According to another aspect of the present disclosure, a method executed by a transaction system is a transaction method executed by the transaction system executing a transaction with a customer by cooperation of a first terminal disposed in a sales office of a financial institution and a second terminal disposed in a location different from the sales office. The first terminal executes first processing related to the transaction and transmits data related to the transaction to the second terminal. The second terminal executes second processing related to the transaction and provides a time stamp to at least part of the data related to the transaction before the second processing is started.

According to still another aspect of the present disclosure, a relay device is a device relaying communication between the first terminal and the second terminal, and includes a providing circuitry that provides a time stamp to data. The first terminal is disposed in a sales office of a financial institution, and executes first processing related to a transaction with a customer. The second terminal receives data related to the transaction from the first terminal, and executes second processing related to the transaction. The second terminal is disposed in a location different from the sales office. The providing circuitry provides a time stamp to at least part of the data related to the transaction before the second processing is started.

According to still another aspect of the present disclosure, a program causes a computer of a device, which relays communication between a first terminal and a second terminal, to implement a function to provide a time stamp to data. The first terminal is disposed in a sales office of a financial institution, and executes first processing related to a transaction with a customer. The second terminal receives data related to the transaction from the first terminal, and executes second processing related to the transaction. The second terminal is disposed in a location different from the sales office. The program provides a time stamp to at least part of the data related to the transaction before the second processing is started.

### <System Configuration>

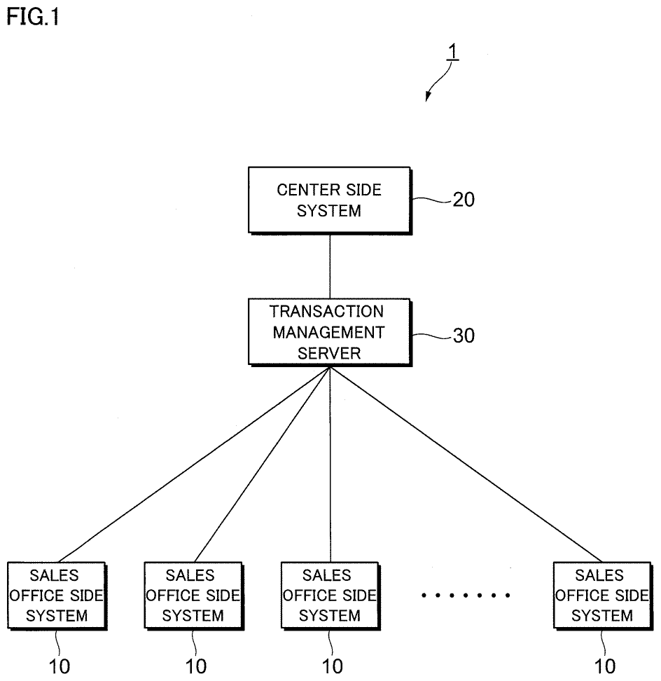

FIG. 1 is a diagram illustrating an example of a medium transaction system.

The media transaction system 1 shown in FIG. 1 is configured with a system disposed in a sales office of a financial institution (hereinafter referred to as a “sales office side system”) 10, a system disposed in the center that executes tasks on behalf of the sales office (hereinafter referred to as a “center side system”) 20, and a transaction management server 30 that manages transactions executed between the sales office side system 10 and the center side system 20.

In the case of FIG. 1, plural sales office side systems 10 communicate with the center side system 20 via the transaction management server 30.

In the case of the exemplary embodiment, transactions including identity verification are collectively executed in the center side system 20. For this reason, the operator in charge of the transaction processing needs to be resident only in the center side system 20, and there is no need to be resident in the sales office side system 10.

As a result, it becomes possible to boost staff numbers of the sales position in the sales office. In addition, it is unnecessary to dispose personnel in charge of scrutiny of transactions in the sales offices, and it becomes possible to reduce the skill of personnel in charge of clerical work in the sales offices.

On the other hand, since transactions including cash deposits and withdrawals are executed in a distributed manner between the sales offices and the center side, a mechanism that can isolate dishonest acts such as tampering is required.

For this reason, in the exemplary embodiment, the transaction management server 30 is equipped with a function to provide a time stamp to transaction data until transaction processing is started on the center side, to thereby prevent dishonesty by an operator.

The medium transaction system 1 in the exemplary embodiment is an example of a transaction system.

### <Configuration of Component Device>

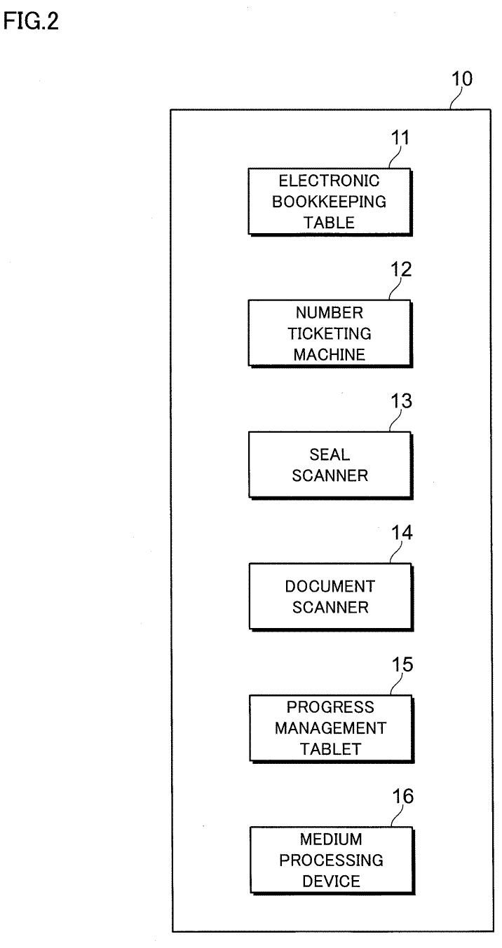

Hereinafter, a description will be given of configuration examples of the sales office side system 10, the center side system 20, and the transaction management server 30 that constitute the medium transaction system 1 by use of FIGS. 2 to 4.

### <Configuration Example of Sales Office Side System>

FIG. 2 is a diagram illustrating a configuration example of the sales office side system 10.

The sales office side system 10 shown in FIG. 2 includes: an electronic bookkeeping table 11; a number ticketing machine 12; a seal scanner 13; a document scanner 14; a progress management tablet 15; and a medium processing device 16.

These terminals are connected to one another via a network. Among these terminals, the electronic bookkeeping table 11, the progress management tablet 15, and the medium processing device 16 can communicate with the transaction management server 30 via a communication device.

The electronic bookkeeping table 11 is a terminal that electronically accepts bookkeeping of a slip necessary for transactions. The electronic bookkeeping table 11 used in the exemplary embodiment is configured with: an operation panel to be operated by a customer; a touch pen to be used for bookkeeping; a CPU (Central Processing Unit); a ROM (Read Only Memory) storing a BIOS (Basic Input Output System), etc.; a RAM (Random Access Memory) used as a work area; and the like. The CPU, ROM, and RAM constitute a computer.

The operation panel is configured with a so-called touch panel, and it is possible to create a slip by input to the operation panel with a touch pen. In the following, the created data of a slip is referred to as “slip data.” The data recorded on the slip is an example of data related to transactions.

In the case of FIG. 2, there is one electronic bookkeeping table 11, but the number of electronic bookkeeping tables is optional. For example, the number of the electronic bookkeeping table 11 may be two, three, or more. Note that the electronic bookkeeping table 11 in the exemplary embodiment is an example of a first terminal.

The number ticketing machine 12 is a device that issues a number ticket on which a number indicating the order of transactions accepted by the electronic bookkeeping table 11 is printed. The number here is linked to the slip data. Therefore, input of the number printed on the receipt to the medium processing device 16 makes it possible to read the corresponding slip data.

Note that a QR code (registered trademark) used to read the slip data may be printed on the number ticket. In the case where the QR code is to be used for reading the slip data, a QR code reader is prepared in the medium processing device 16.

The number ticketing machine 12 is configured with a CPU, a ROM, a RAM, and a printer. As the printer, for example, a thermal printer is used. Incidentally, the number ticketing machine 12 may be integrated with the electronic bookkeeping table 11.

The seal scanner 13 is a device that optically reads the seal used by the customer for transactions and converts the read impression of the seal into data. The seal scanner 13 in the exemplary embodiment is connected to the electronic bookkeeping table 11. The data of the read impression of the seal (hereinafter, referred to as “seal impression data”) is transmitted to the center side system 20 (refer to FIG. 1) via the transaction management server 30 (refer to FIG. 1) together with the slip data. The seal impression data is an example of data used for identity verification (hereinafter, referred to as “identity verification data”), and the seal scanner 13 is an example of an identity verification device.

The seal scanner 13 is configured with a CPU, a ROM, a RAM, a scanner, and the like. A signature input device may be provided as an identity verification device. The signature input device is configured with a so-called touch panel, and it is possible to input a signature to the operation panel with a touch pen. In addition, as the identity verification device, a biological information input device that acquires the customer's biological information may also be provided.

The document scanner 14 is a device that digitizes recorded information in the case where a customer brings a paper slip, or a store also handles a paper slip. The document scanner 14 used in the exemplary embodiment processes characters, which have been optically read, by OCR (Optical Character Recognition) to generate slip data. The generated slip data is provided to the electronic bookkeeping table 11. When the slip data is generated, a receipt on which the number showing the order of transaction is printed is issued by the number ticketing machine 12. Note that, to the generated slip data, the number issued by the number ticketing machine 12 is linked.

The document scanner 14 is also configured with a CPU, a ROM, a RAM, a scanner, and the like.

The progress management tablet 15 is a tablet terminal that guides the number of customers who are waiting for their turn and the customers who are in turn to the medium processing device 16. In the exemplary embodiment, a tablet-type terminal carried by the sales office staff is assumed, but the device may be a stationary terminal. Note that the stationary terminal is also called a guide device.

The progress management tablet 15 is configured with a CPU, a ROM, a RAM, a touch panel, and the like.

The medium processing device 16 is a device used for the deposit and withdrawal of loose banknotes and loose coins, the withdrawal of rolled coins, the withdrawal of bundles of banknotes, etc. The medium processing device 16 may be a device that processes media other than money. For example, the medium processing device 16 may take in and process checks.

The media handling device 16 may cash checks and tickets. The medium processing device 16 used in the exemplary embodiment is of the self-operated type, and can be operated, not only by the staff on the financial institution side, but also by the customer.

The medium processing device 16 includes: a device that processes the loose banknotes; a device that processes paper-banded banknotes; a device that processes the loose coins; a device that processes the rolled coins; and a control circuitry that controls these devices.

The device that processes the loose banknotes performs the deposit processing for storing the loose banknotes that have been put into a deposit port in a storage container, and the withdrawal processing for transferring the loose banknotes stored in the storage container to a withdrawal port to be paid.

The medium processing device 16 may include a device that processes media other than money such as checks, gift certificates, and tickets. For example, a check device performs processing that reads a check put into the deposit port and stores the check in the storage container. For example, a ticket device performs processing that transfers a ticket stored in the storage container to the withdrawal port.

The device that processes the paper-banded banknotes performs processing that creates and stores paper-banded banknotes in which a predetermined number of loose banknotes are bundled into one to be stored, and processing that withdraws paper-banded banknotes of specified denominations and number of bundles.

The device that processes the loose coins performs the deposit processing for storing the loose coins put to the deposit port in the storage container, and the withdrawal processing for transferring the loose coins in the storage container to the withdrawal port to be paid.

The device that processes the rolled coins performs processing that creates and stores rolled coins in which a predetermined number of loose coins are packaged cylindrically to be stored, and processing that withdraws rolled coins of specified denominations and number of rolls.

The control circuitry manages flow of money in the sales offices of the financial institution by controlling the above-described devices. The control circuitry is configured with a CPU, a ROM, and a RAM.

### <Configuration Example of Center Side System>

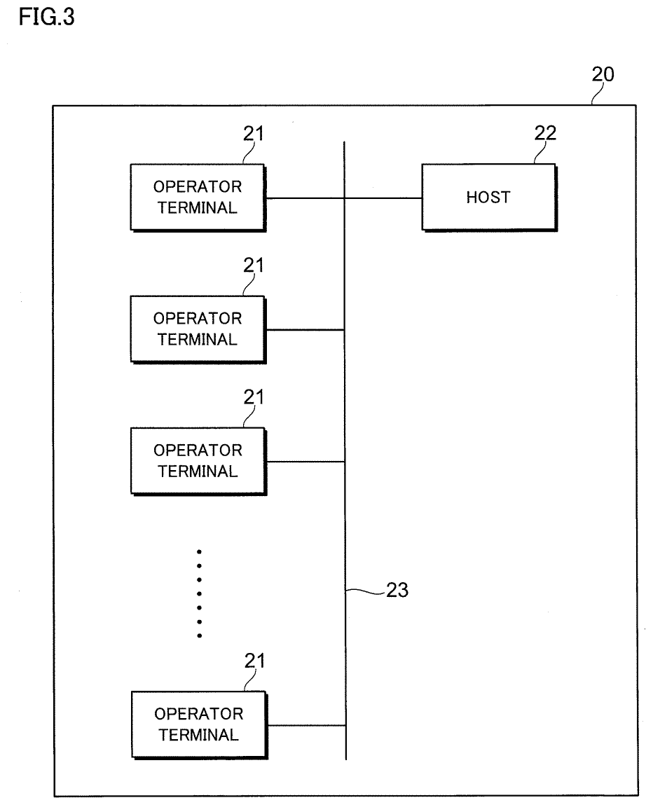

FIG. 3 is a diagram illustrating a configuration example of the center side system 20.

The center side system 20 shown in FIG. 3 includes: plural operator terminals 21 operated by operators who are in charge of account processing among the transaction processing; a host 22 that manages data related to the account processing collectively; and a network 23 such as a WAN (Wide Area Network) that connects thereof. These terminals can communicate with the transaction management server 30 via a communication device. Note that the host 22 is an example of an accounting system. The accounting system is a system that manages customer's accounts and is sometimes called a core banking system.

The operator terminal 21 has a configuration including a body as a computer, a display and a keyboard connected thereto. The body as a computer is provided with a CPU, a ROM, a RAM, a hard disk device as an auxiliary storage device, and the like. A large-capacity and non-volatile semiconductor memory may be used as the auxiliary storage device.

The operator terminal 21 in the exemplary embodiment is an example of a second terminal.

### <Configuration of Transaction Management Server>

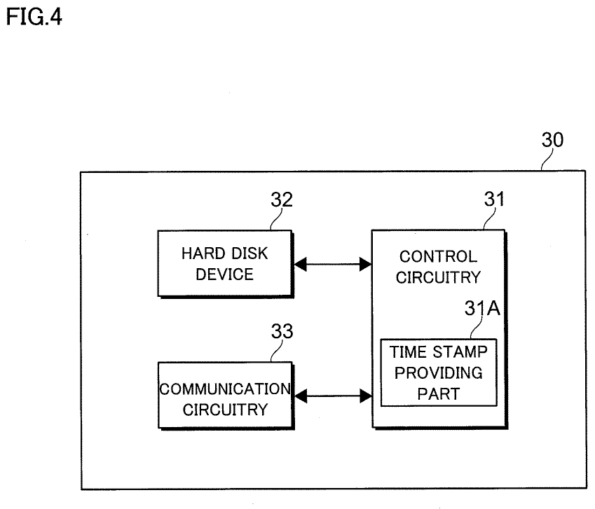

FIG. 4 is a diagram illustrating a configuration example of the transaction management server 30.

The transaction management server 30 shown in FIG. 4 manages the progress of transaction processing by relaying the communication executed between the sales office side system 10 and the center side system 20. Since being a server, the basic configuration of the transaction management server 30 is a computer. In the case of FIG. 4, the transaction management server 30 includes a control circuitry 31, a hard disk device 32, and a communication circuitry 33. The communication circuitry 33 here is an example of a notification part.

The control circuitry 31 includes a CPU, a ROM, and a RAM. The control circuitry 31 provides various types of functions through the execution of application programs read from the hard disk device 32 as the auxiliary storage device.

FIG. 4 shows a time stamp providing part 31A as an example of a function implemented through the execution of an application program. The providing part 31A may be configured as a circuitry.

The time stamp providing part 31A offers a function to provide a time stamp to received slip data. The time stamp may be metadata indicating the time of receipt of the slip data, but may also be more reliable data. Specifically, a time certificate authority assigns a time stamp using the cryptographic technology to a hash value of the received slip data. In the case of the exemplary embodiment, the transaction management server 30 also serves as the time certificate authority. However, the time stamp may be obtained from an external time certificate authority. This can prove that the slip data existed at the time indicated by the time stamp, and that the slip data has not been tampered with since that time.

In the exemplary embodiment, a hard disk device 32 is used as the auxiliary storage device to store application programs and operating systems that implement the time stamp providing part 31A.

### <Processing Operations>

### <Operations in Withdrawal>

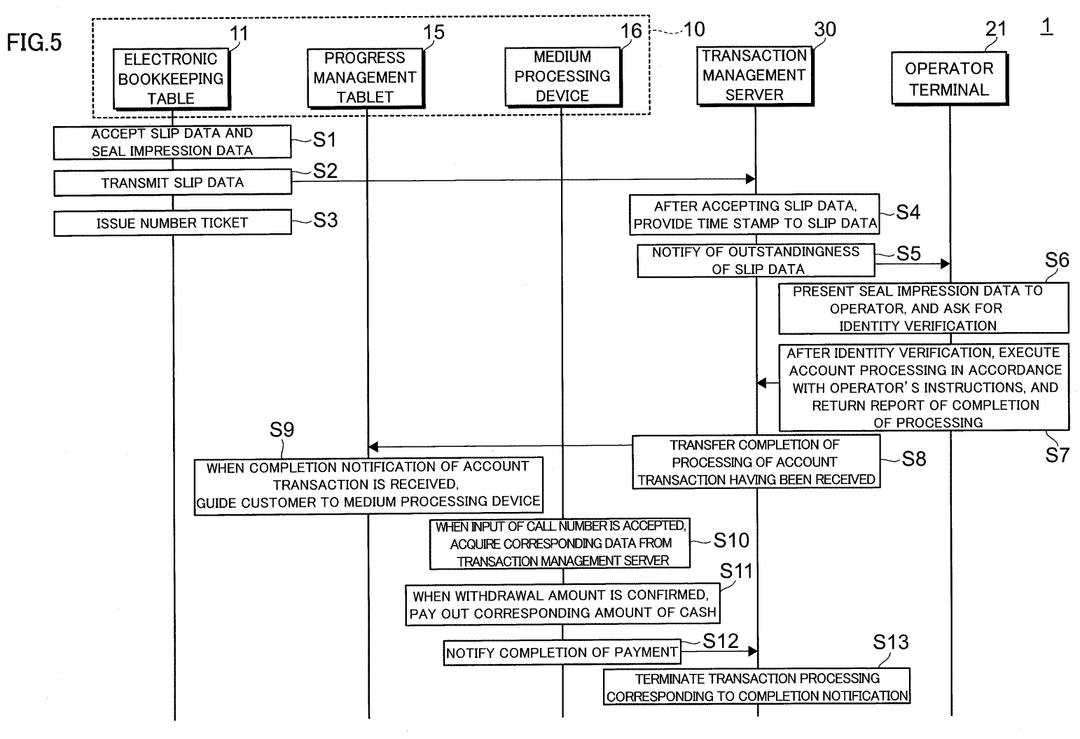

FIG. 5 is a diagram illustrating an example of processing operations in the case where the cash withdrawal processing is executed in the medium transaction system 1. The symbol S shown in the figure indicates a step. Note that, in FIG. 5, the electronic bookkeeping table 11, the number ticketing machine 12, the seal scanner 13, and the document scanner 14 are collectively shown as the electronic bookkeeping table 11.

The processing operations related to the withdrawal are started in the sales office side system 10. The processing operations here are the transaction processing that requires identity verification.

First, the electronic bookkeeping table 11 performs acceptance processing (the first processing). The electronic bookkeeping table 11 accepts slip data through operations of a customer or a sales office staff (step 1). The acceptance processing may include the processing that accepts the data for identity verification. For example, the identity verification data is seal impression data, and the seal impression data is accepted by the seal scanner 13. The data for identity verification may be signature data or biometric data.

Next, the electronic bookkeeping table 11 transmits the slip data to the transaction management server 30 (step 2). The electronic bookkeeping table 11 may transmit the data for identity verification together. In addition, the electronic bookkeeping table 11 may issue a number ticket via the number ticketing machine 12 that is cooperating (step 3).

After accepting the slip data, the transaction management server 30 provides a time stamp to the slip data (step 4).

Subsequently, the transaction management server 30 notifies the operator terminal 21 of outstandingness of the slip data (step 5).

When receiving the time-stamped slip data, the operator terminal 21, which is the communication destination, presents the data for identity verification to the operator who is in charge of procedures of the received slip data, and asks for the identity verification (step 6). Here, the operator checks the received data for identity verification against the data for identity verification registered in the host 22, and confirms that the procedures are carried out by the identical person.

After the identity verification, the operator terminal 21 executes the account processing (the second processing) in accordance with the operator's instructions, and returns a report of completion of the processing (step 7).

The transaction management server 30 transfers the result of account processing performed based on the received slip data to the progress management tablet 15 of the sales office side system 10 (step 8).

When receiving the results of the account processing from the transaction management server 30, the progress control tablet 15 guides the customer to the medium processing device 16 (step 9). Specifically, the progress management tablet 15 notifies the customer that his/her turn comes by displaying the call number corresponding to the notification, making announcements, etc. Note that the sales office staff may confirm the coming of the turn on the progress management tablet 15, and may guide the relevant customer to the medium processing device 16. The medium processing device 16 used in the exemplary embodiment can be operated by the customer.

The medium processing device 16 performs the medium processing. Specifically, when receiving a specific code input by the customer, the medium processing device 16 obtains the corresponding data from the transaction management server 30 (step 10). The specific code is, for example, the call number corresponding to the processing result received by the progress management tablet 15 from the transaction management server 30. The specific code may be the code written on the number ticket issued by the electronic bookkeeping table 11 via the cooperating number ticketing machine 12. The medium processing device 16 shows the withdrawal amount to the customer. When the withdrawal amount is confirmed by the customer, the medium processing device 16 pays out the corresponding amount of cash (step 11).

Thereafter, the medium processing device 16 notifies the transaction management server 30 of the completion of the payment (step 12).

Upon receiving the notification, the transaction management server 30 terminates the transaction processing corresponding to the completion notification (step 13).

### <Operations in Deposit>

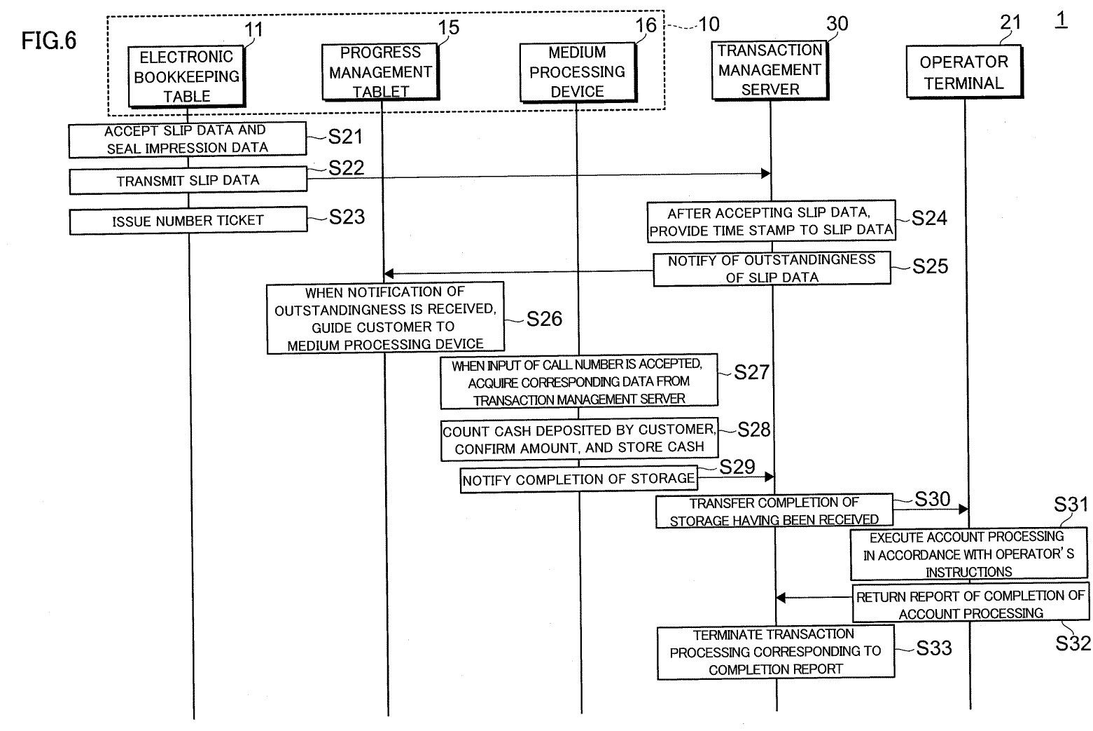

FIG. 6 is a diagram illustrating an example of processing operations in the case where the cash deposit processing is executed in the medium transaction system 1. The symbol S shown in the figure indicates a step. In the case of FIG. 6, also, the electronic bookkeeping table 11, the number ticketing machine 12, the seal scanner 13, the case of the document scanner 14 are collectively shown as the electronic bookkeeping table 11.

The processing operations related to the deposit are also started in the sales office side system 10. The processing operations here are also the transaction processing that requires identity verification.

First, the electronic bookkeeping table 11 performs acceptance processing (the first processing). The electronic bookkeeping table 11 accepts slip data through operations of a customer or a sales office staff (step 21). The acceptance processing may include the processing that accepts the data for identity verification. For example, the identity verification data is seal impression data, and the seal impression data is accepted by the seal scanner 13.

Next, the electronic bookkeeping table 11 transmits the slip data to the transaction management server 30 (step 22). The electronic bookkeeping table 11 may transmit the data for identity verification together. In addition, the electronic bookkeeping table 11 issues a number ticket via the number ticketing machine 12 that is cooperating (step 23).

After accepting the slip data, the transaction management server 30 provides a time stamp to the slip data (step 24).

Subsequently, the transaction management server 30 notifies the progress management tablet 15 of outstandingness of the slip data (step 25).

When receiving the notification of outstandingness, the progress control tablet 15, which is the communication destination, guides the customer to the medium processing device 16 (step 26). Specifically, the progress management tablet 15 notifies the customer that his/her turn comes by displaying the call number corresponding to the notification, making announcements, etc. Note that the sales office staff may confirm the coming of the turn on the progress management tablet 15, and may guide the relevant customer to the medium processing device 16. The medium processing device 16 used in the exemplary embodiment can be operated by the customer.

The medium processing device 16 performs the medium processing. Specifically, when receiving a specific code input by the customer (step 27), the medium processing device 16 counts the cash deposited by the customer, confirms the amount, and then stores the cash (step 28). The specific code is, for example, the call number corresponding to the notification received by the progress management tablet 15 from the transaction management server 30. The specific code may be the code written on the number tag issued by the electronic bookkeeping table 11 via the cooperating number tag issuing machine 12. Thereafter, the medium processing device 16 notifies the transaction management server 30 of the completion of storage (step 29).

The transaction management server 30 that has received the notification of completion of storage from the medium processing device 16 transfers the received completion of storage to the operator terminal 21 (step 30).

Upon receiving the time-stamped slip data together with the notification of completion of storage, the operator terminal 21 executes the account processing in accordance with instructions from the operator who is in charge of procedures of the slip data (step 31).

Thereafter the operator terminal 21 returns a report of completion of the account processing to the transaction management server 30 (step 32).

Upon receiving the notification, the transaction management server 30 terminates the transaction processing corresponding to the completion notification (step 33).

### CONCLUSION

In the exemplary embodiment, both at the time of withdrawal and at the time of deposit, a time stamp is provided to slip data before the slip data is delivered to the center side system 20 (refer to FIG. 1); accordingly, it becomes possible to prevent tampering by the operator who is in charge of transaction processing, and to clarify who is responsible in the case where a miscalculation is found.

In the exemplary embodiment, a system that adds a service to change the transaction order of a good customer will be described.

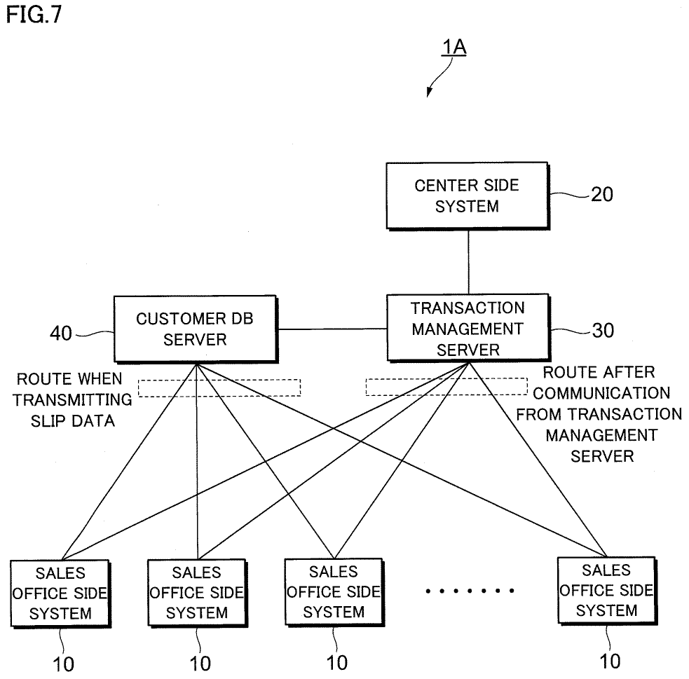

FIG. 7 is a diagram illustrating an example of a medium transaction system 1A. In FIG. 7, components corresponding to those of FIG. 1 are assigned with same reference signs.

In the case of the exemplary embodiment, a customer database server (hereinafter, referred to as a “customer DB server”) 40 is added between the sales office side systems 10 and the transaction management server 30. The customer DB server 40 is used only when the slip data is transmitted from the sales office side system 10. The customer DB server 40 is an example of a fourth terminal.

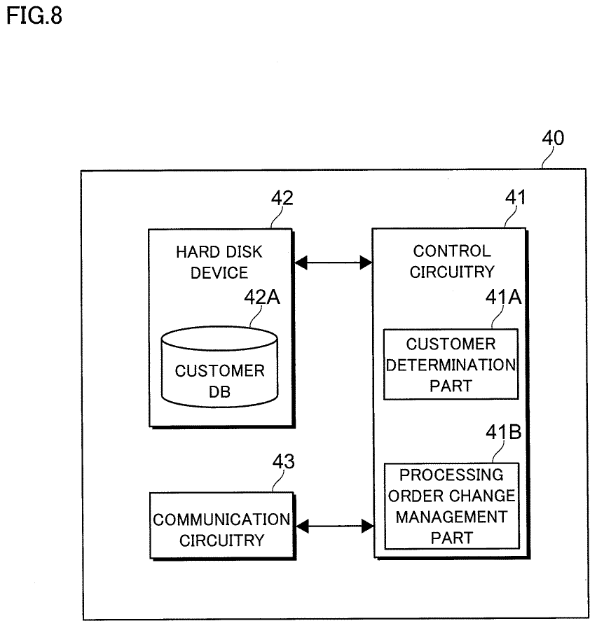

FIG. 8 is a diagram illustrating a configuration example of the customer DB server 40.

The basic configuration of the customer DB server 40 shown in FIG. 8 is a computer.

In the case of FIG. 8, the customer DB server 40 includes a control circuitry 41, a hard disk device 42, and a communication circuitry 43.

The control circuitry 41 includes a CPU, a ROM, and a RAM. The control circuitry 41 provides various types of functions through the execution of application programs read from the hard disk device 42 as an auxiliary storage device.

FIG. 8 shows a customer determination part 41A, and a processing order change management part 41B as an example of functions implemented through the execution of application programs. The customer determination part 41A may be configured as a circuitry. The processing order change management part 41B may be configured as a circuitry.

The customer determination part 41A reads information of the customer requesting the transaction from the received slip data, and provides a function to determine whether or not the customer is a good customer. Whether the customer is a good customer or not is determined with reference to the customer database (hereinafter, referred to as a “customer DB”) 42A. The customer DB 42A records data about whether the customers of the financial institution are good customers or not.

In the case where the customer requesting the transaction is a good customer of the financial institution, in transferring the slip data, the processing order change management part 41B provides instructions that the order of transaction processing is changed to a higher rank. In other words, it means that a customer not regarded as a good customer is changed to a lower rank in the order of transaction processing. Note that, in the case where the customer requesting the transaction is not a good customer of the financial institution, the processing order change management part 41B transfers the slip data only, and does not provide instructions to change the processing order.

In the case of the exemplary embodiment, the hard disk device 42 is also used as the auxiliary storage device. The hard disk device 42 stores the customer DB 42A in addition to the application programs and operating systems that implement the customer determination part 41A and the processing order change management part 41B.

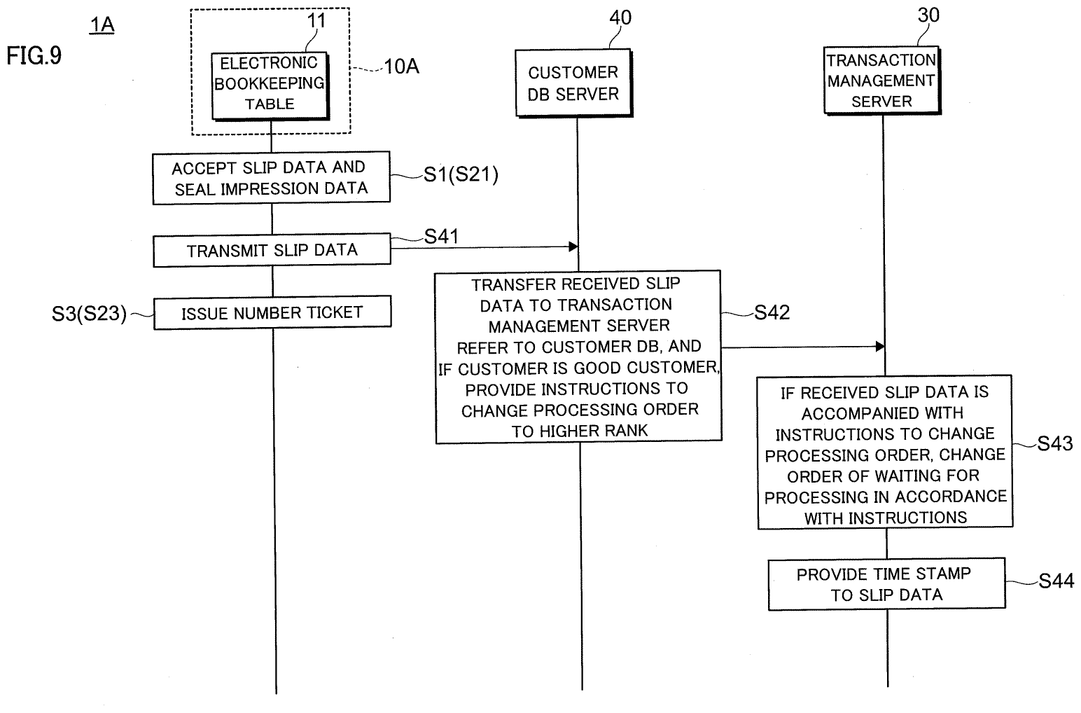

FIG. 9 is a diagram illustrating an example of processing operations in the case where the cash withdrawal processing and the cash deposit processing are executed in the medium transaction system 1A. In FIG. 9, components corresponding to those of FIGS. 5 and 6 are assigned with same reference signs. The symbol S shown in the figure indicates a step. Note that, in FIG. 9, the reference signs indicating the processing operations of FIG. 6 are parenthesized.

Similar to described exemplary embodiment, the processing operations related to the withdrawal are started in the sales office side system 10.

First, the electronic bookkeeping table 11 performs the acceptance processing that accepts the slip data through operations of a customer or a sales office staff (step 1). The electronic bookkeeping table 11 may accept data for identity verification. For example, the identity verification data is seal impression data, and the seal impression data is accepted by the seal scanner 13.

Next, the electronic bookkeeping table 11 transmits the slip data to the customer DB server 40 (step 41). The electronic bookkeeping table 11 may transmit the data for identity verification together. Note that, the electronic bookkeeping table 11 may issue a number ticket via the number ticketing machine 12 that is cooperating (step 3).

The customer DB server 40 transfers the received slip data to the transaction management server 30. In addition, the customer DB server 40 refers to the customer DB 42A, and in the case where the customer is a good customer, provides instructions that the processing order is changed to a higher rank (step 42). Specifically, instructions to change the order of execution of transaction processing are provided to the slip data. The instruction here is an example of data indicating that the execution order needs to be changed.

In the case where the received slip data is accompanied with instructions to change the processing order, the transaction management server 30 changes the order of waiting for the processing in accordance with the instructions (step 43). Naturally, if there is no instruction to change the processing order for the received slip data, the transaction management server 30 does not change the processing order managed by itself In this case, the processing order remains the order of acceptance.

Thereafter, the transaction management server 30 provides a time stamp to the slip data (step 44).

Note that, in the case of the withdrawal processing, the transaction management server 30 notifies the center side system 20 of the outstandingness of the slip data (step 5 in FIG. 5).

On the other hand, in the case of the deposit processing, the transaction management server 30 notifies the progress management tablet 15 of the outstandingness of the slip data (step 25 in FIG. 6).

The subsequent processing is the same as described exemplary embodiment.

In the case of the exemplary embodiment, the transaction management server 30 changes the processing order based on the determination on whether or not the customer is a good customer and the time stamps provided to the slip data of other customers. The transaction management server 30 determines whether or not the customer is a good customer before the slip data is delivered from the sales office side system 10 to the transaction management server 30. In the case of the good customer, the transaction management server 30 refers to the time stamps provided to the slip data of other customers. The transaction management server 30 identifies other customers who have been accepted at almost the same time, but are not the good customers, and other customers who have already been accepted and waiting for the processing, but are not the good customers. The transaction management server 30 becomes able to change the processing order of the good customer higher than the order of the other identified customers.

In the case of the exemplary embodiment, it is possible to reduce the waiting time required for transactions with the good customers of the financial institution, to thereby increase customer satisfaction of the good customers.

Of course, since the time stamp has already been provided to the slip data delivered to the center side system 20, it becomes possible to prevent tampering by the operator who is in charge of transaction processing, and to clarify who is responsible in the case where a miscalculation is found.

In the case of above-described exemplary embodiment, the customer DB server 40 (refer to FIG. 7) that has received the slip data determines whether or not the customer is a good customer, and in the case of a good customer, instructs the transaction management server 30 (refer to FIG. 7) to change the processing order; however, it is possible to change the processing order by other methods.

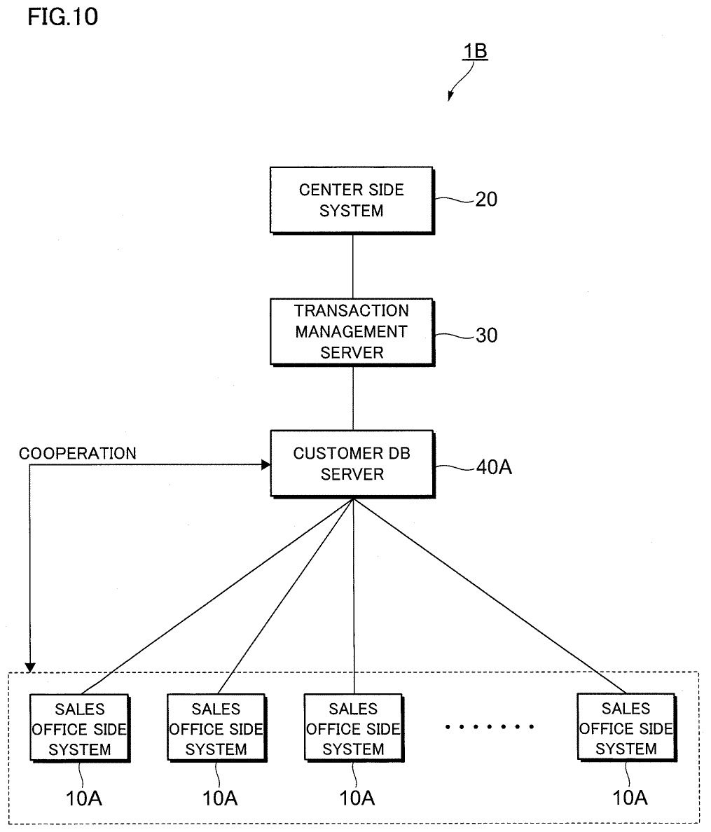

FIG. 10 is a diagram illustrating an example of a medium transaction system 1B. In FIG. 10, components corresponding to those of FIG. 7 are assigned with same reference signs.

In the exemplary embodiment, the processing operations are realized by cooperation between sales office side systems 10A and a customer DB server 40A.

In the case of the exemplary embodiment, the customer DB 42A (refer to FIG. 8) is also stored in the hard disk device 42 (refer to FIG. 8) of the customer DB server 40A. However, the determination of whether or not a customer is a good customer is executed by the sales office side systems 10A. In the case of the exemplary embodiment, the electronic bookkeeping table 11 (refer to FIG. 2), which transmits the slip data, determines whether or not a customer is a good customer.

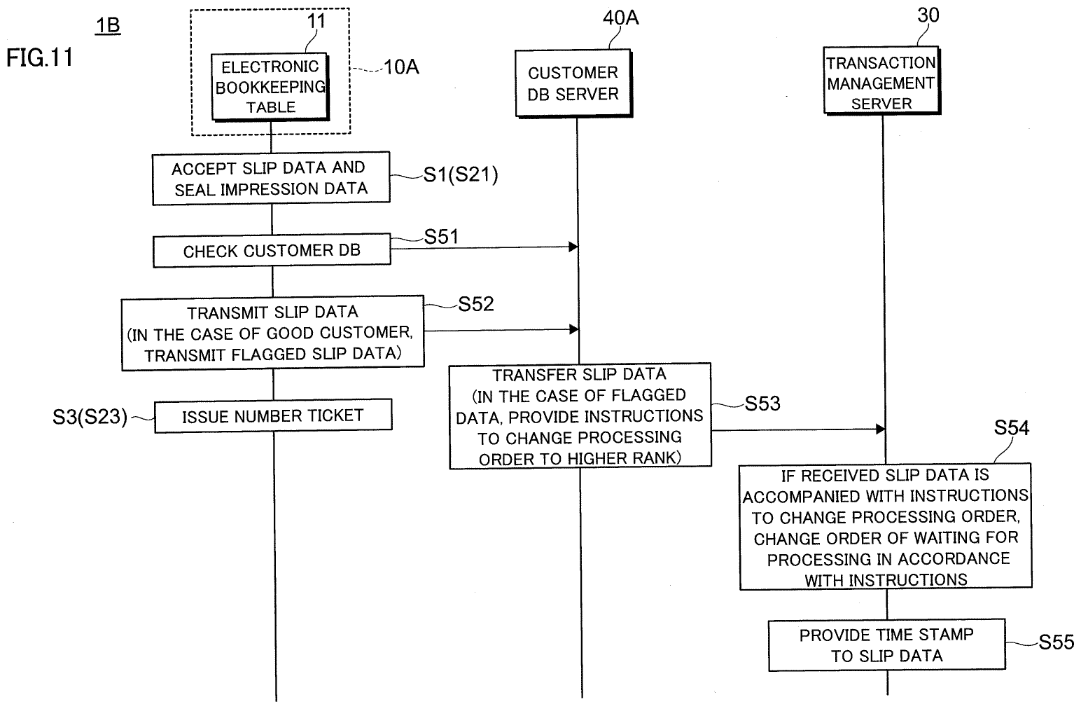

FIG. 11 is a diagram illustrating an example of processing operations in the case where the cash withdrawal processing and the cash deposit processing are executed in the medium transaction system 1B. In FIG. 11, components corresponding to those of FIGS. 5 and 6 are assigned with same reference signs. The symbol S shown in the figure indicates a step. Note that, in FIG. 11, the reference signs indicating the processing operations of FIG. 6 are parenthesized.

Similar to described exemplary embodiment, the processing operations related to the withdrawal are started in the sales office side system 10A.

First, the electronic bookkeeping table 11 performs the acceptance processing that accepts the slip data through operations of a customer or a sales office staff (step 1). The electronic bookkeeping table 11 may accept data for identity verification. For example, the identity verification data is seal impression data, and the seal impression data is accepted by the seal scanner 13.

The electronic bookkeeping table 11 that has received the slip data accesses the customer DB server 40A and checks thereof against the customer DB 42A (refer to FIG. 8) (step 51). Specifically, the electronic bookkeeping table 11 determines whether or not the target customer for transaction is a good customer.

Next, the electronic bookkeeping table 11 transmits the slip data to the customer DB server 40A. The electronic bookkeeping table 11 may transmit the data for identity verification together. Note that, in the case of the good customer, the electronic bookkeeping table 11 transmits flagged slip data to the customer DB server 40A (step 52). The flag here indicates that the transaction is with a good customer and the order of execution needs to be changed. In other words, the flag that instructs to change the order of execution is provided to the slip data. The flag here is an example of data indicating that the execution order needs to be changed.

Thereafter, the electronic bookkeeping table 11 may issue a number ticket via the number ticketing machine 12 that is cooperating (step 3).

The customer DB server 40A in the exemplary embodiment transfers the received slip data to the transaction management server 30. At this time, in the case where the received slip data is flagged, the customer DB server 40A instructs to change the processing order to a higher rank (step 53).

In the case where the received slip data is accompanied with instructions to change the processing order, the transaction management server 30 changes the order of waiting for the processing in accordance with the instructions (step 54). Naturally, if there is no instruction to change the processing order for the received slip data, the transaction management server 30 does not change the processing order managed by itself In this case, the processing order remains the order of acceptance.

Thereafter, the transaction management server 30 provides a time stamp to the slip data (step 55).

The subsequent processing is the same as above-described exemplary embodiment.

In other words, in the case of the withdrawal processing, the transaction management server 30 notifies the center side system 20 of the outstandingness of the slip data (step 5 in FIG. 5).

On the other hand, in the case of the deposit processing, the transaction management server 30 notifies the progress management tablet 15 of the outstandingness of the slip data (step 25 in FIG. 6).

In the above-described exemplary embodiment, the time stamp is provided while the slip data is delivered from the sales office side system 10 (refer to FIG. 1) to the center side system 20; however, the time stamp may be provided after the receipt of the slip data by the center side system 20, but before the transaction processing of the slip data is started by the operator. That is, in a system configuration that does not use the transaction management server 30, the time stamp may be provided by the center side system 20.

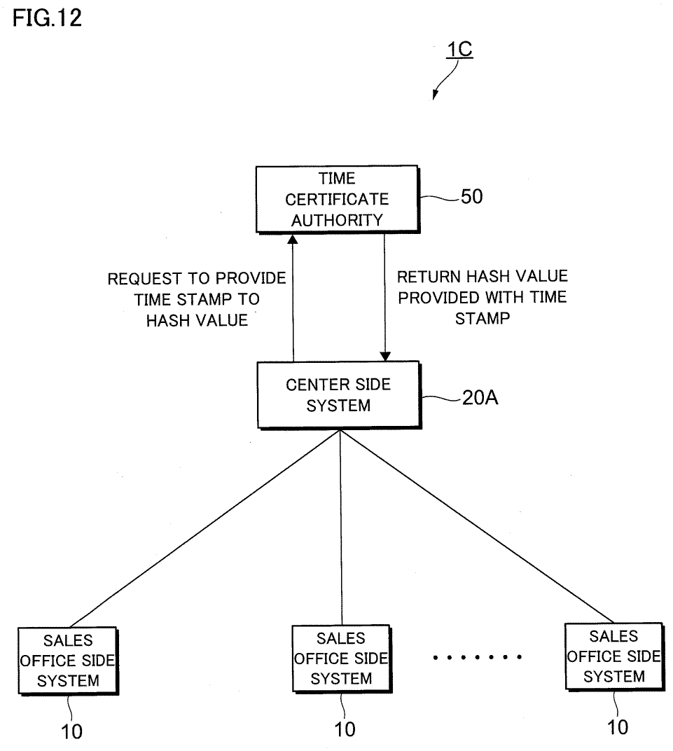

FIG. 12 is a diagram illustrating an example of a medium transaction system 1C. In FIG. 12, components corresponding to those of FIG. 1 are assigned with same reference signs.

When a center side system 20A of the sales office side systems 10 shown in FIG. 12 receives the slip data from the sales office side system 10, the center side system 20A calculates the hash value of the slip data and requests the time certificate authority 50 to provide the time stamp before the operator's processing is started. The time certificate authority 50, on the other hand, returns the hash value provided with the time stamp using the cryptographic technology to the center side system 20A. This makes it possible, in the case where the slip data has been altered, to identify that the alteration is made after the operation by the operator.

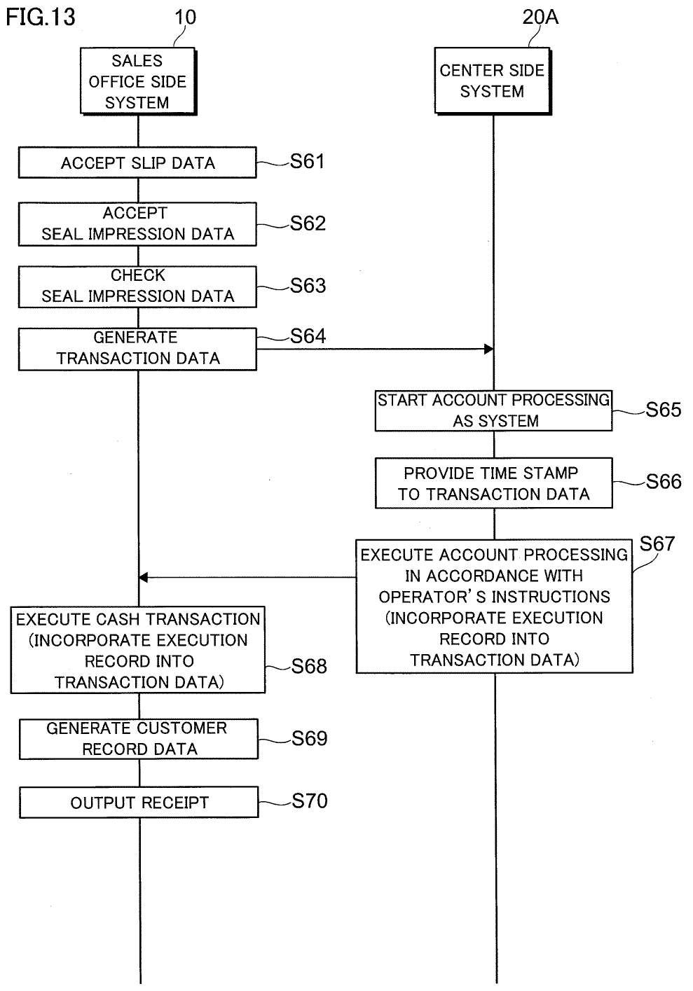

FIG. 13 is a diagram illustrating an example of processing operations in the case where the cash withdrawal processing is executed in the medium transaction system 1C (refer to FIG. 12). The symbol S shown in the figure indicates a step.

The processing operations related to the withdrawal are started in the sales office side system 10. The processing operations here are the transaction processing that requires identity verification.

First, the electronic bookkeeping table 11 (refer to FIG. 2) performs the acceptance processing that accepts the slip data through operations of a customer or a sales office staff (step 61).

Next, the electronic bookkeeping table 11 may accept the data for identity verification. For example, in the case where the identity verification data is seal impression data, the seal scanner 13 (refer to FIG. 2) accepts the seal impression data (step 62).

Subsequently, the sales office staff checks the accepted identity verification data against the identity verification data registered in a master DB (step 63). The master DB is stored in the hard disk device, etc. of the center side system 20A, for example. In the case of the exemplary embodiment, identity verification is performed on the sales office side.

Upon completion of the identity verification, the sales office side system 10 generates transaction data (step 64). The generated transaction data is transmitted to the center side system 20A. The transaction data includes, for example, slip data. The transaction data may include the identity verification data.

Upon receiving the transaction data, the center side system 20A starts the account processing as a system (step 65). The start of the account processing as a system does not mean the start of processing of the operator who is in charge of the account processing.

Being triggered by the start of the account processing as a system, the center side system 20A provides a time stamp to the transaction data (step 66). Specifically, the center side system 20A generates a hash value of the received transaction data, transmits thereof to the time certificate authority 50 (refer to FIG. 12), and accepts a time-stamped hash value reply.

When the time stamp is provided, the center side system 20A notifies the operator terminal 21 operated by the operator in charge of account processing (refer to FIG. 3) of the slip data. Thereafter, the center side system 20A executes the account processing in accordance with the instructions from the operator. In addition, the center side system 20A incorporates the execution record of the account processing (the second processing) into the transaction data (step 67).

Thereafter, the center side system 20A returns the transaction data to the sales office side system 10. The center side system 20A terminates the account processing as a system.

The sales office side system 10 that has received the transaction data reply executes the medium processing, and incorporates the execution record of the medium processing into the transaction data (step 68). In this step, the corresponding amount of cash is paid to the customer.

Thereafter, the sales office side system 10 generates customer record data (step 69) to output a receipt (step 70).

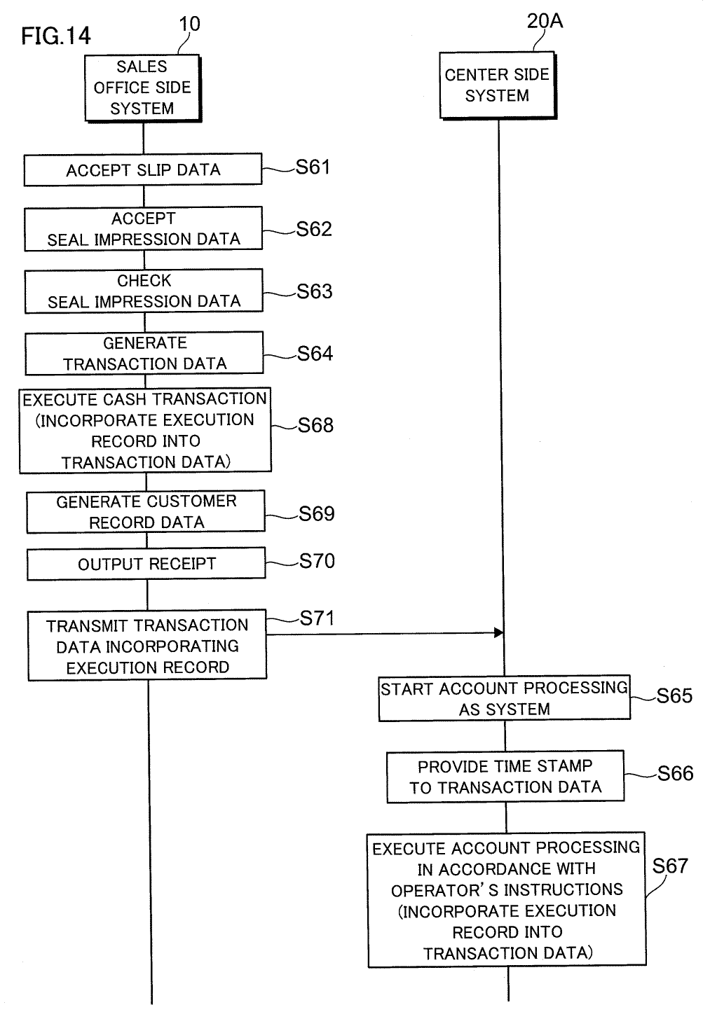

FIG. 14 is a diagram illustrating an example of processing operations in the case where the cash deposit processing is executed in the medium transaction system 1C (refer to FIG. 12). The symbol S shown in the figure indicates a step. In FIG. 14, components corresponding to those of FIG. 13 are assigned with same reference signs.

The processing operations related to the deposit are also started in the sales office side system 10. The processing operations here are the transaction processing that requires identity verification.

First, the electronic bookkeeping table 11 (refer to FIG. 2) performs the acceptance processing that accepts the slip data through operations of a customer or a sales office staff (step 61).

Next, the electronic bookkeeping table 11 may accept the data for identity verification. For example, in the case where the identity verification data is seal impression data, the seal scanner 13 (refer to FIG. 2) accepts the seal impression data (step 62).

Subsequently, the sales office staff checks the accepted identity verification data against the identity verification data registered in a master DB (step 63). The master DB is stored in the hard disk device, etc. of the center side system 20A. In the case of the exemplary embodiment, identity verification is carried out on the sales office side.

Upon completion of the identity verification, the sales office side system 10 generates transaction data (step 64). The transaction data includes, for example, slip data and identity verification data.

Here, the sales office side system 10 executes the medium processing, and incorporates the execution record of the medium processing into the transaction data (step 68). In this step, the corresponding amount of cash is stored in the medium processing device 16 (refer to FIG. 2).

Thereafter, the sales office side system 10 generates customer record data (step 69) to output a receipt (step 70).

When the receipt is output, the sales office side system 10 transmits the transaction data, into which the execution record has been incorporated, to the center side system 20A (step 71).

Upon receiving the transaction data, the center side system 20A starts the account processing as a system (step 65). The start of the account processing as a system does not mean the start of processing of the operator who is in charge of the account processing.

Being triggered by the start of the account processing as a system, the center side system 20A provides a time stamp to the transaction data (step 66). Specifically, the center side system 20A generates a hash value of the received transaction data, transmits thereof to the time certificate authority 50 (refer to FIG. 12), and accepts a time-stamped hash value reply.

When the time stamp is provided, the center side system 20A notifies the operator terminal 21 operated by the operator in charge of account processing (refer to FIG. 3) of the slip data. Thereafter, the center side system 20A executes the account processing in accordance with the instructions from the operator. In addition, the center side system 20A incorporates the execution record of the account processing into the transaction data (step 67).

Thereafter, the center side system 20A terminates the account processing as a system.

In the case of the above-described exemplary embodiment, the account processing is carried out not by the sales office but by an operator of the center side system 20 (refer to FIG. 1), etc.; however, in the exemplary embodiment, a description will be given of a case in which the account processing is completed in the sales office.

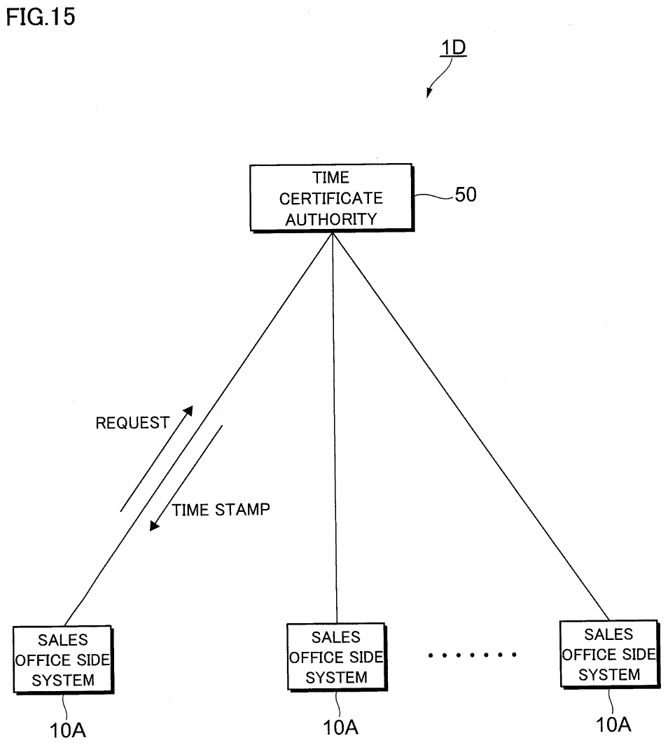

FIG. 15 is a diagram illustrating an example of a medium transaction system 1D. In FIG. 15, components corresponding to those of FIG. 1 are assigned with same reference signs.

The medium transaction system 1D shown in FIG. 15 is configured with the sales office side systems 10A and the time certificate authority 50.

The sales office side system 10A in the exemplary embodiment provides a time stamp to the slip data before the processing of the staff in the sales office is started. The time stamp is provided to the hash value of the slip data. This makes it possible, in the case where there is a miscalculation between the generated slip data and the contents of the account processing, to identify that the miscalculation is caused by alteration after the operation by the staff.

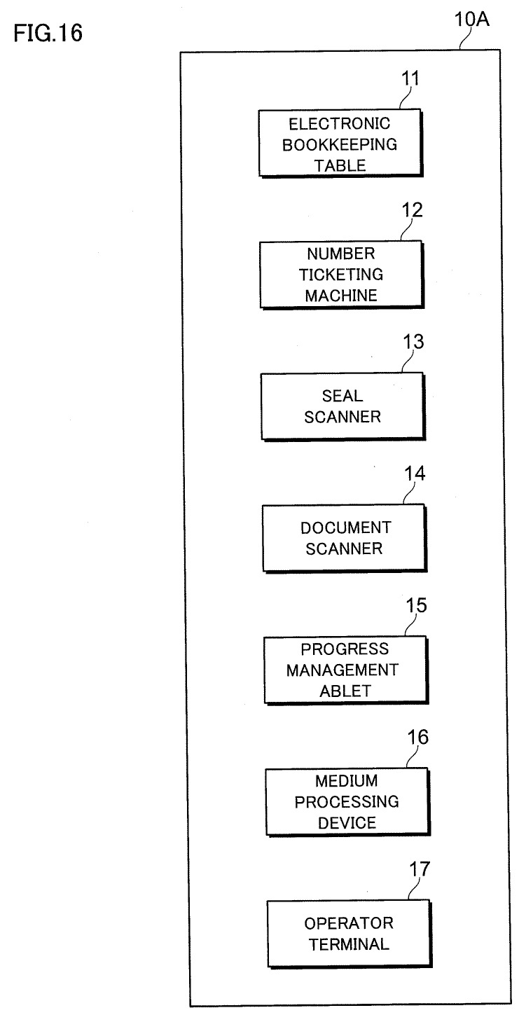

FIG. 16 is a diagram illustrating a configuration example of the sales office side system 10A. In FIG. 16, components corresponding to those of FIG. 2 are assigned with same reference signs.

The sales office side system 10A shown in FIG. 16 is different from the sales office side system 10 shown in FIG. 2 in the point that the sales office side system 10A includes an operator terminal 17. The operator terminal 17 in the exemplary embodiment is operated by the staff in the sales office.

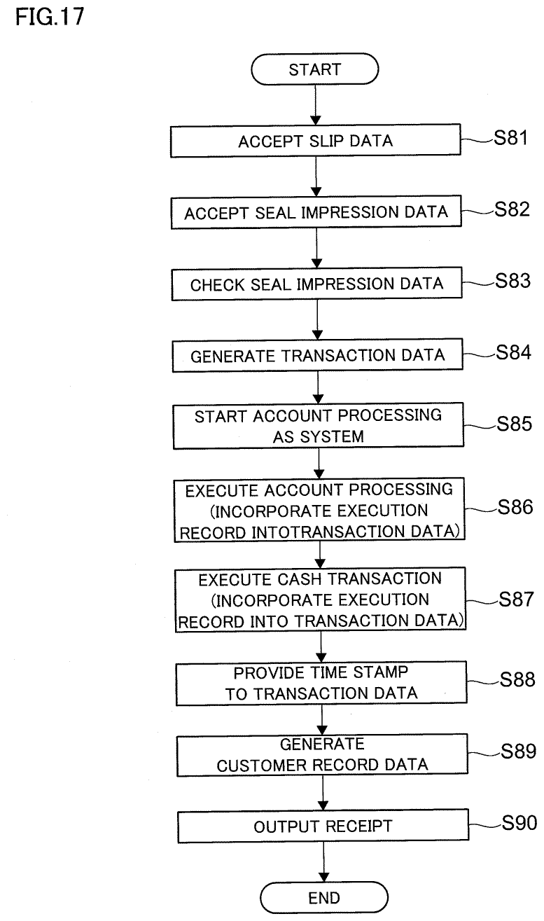

FIG. 17 is a diagram illustrating an example of processing operations in the case where the cash withdrawal processing or the cash deposit processing is executed in the medium transaction system 1D (refer to FIG. 15). The symbol S shown in the figure indicates a step.

In the case of the exemplary embodiment, all of the processing operations are executed in the sales office side system 10A. The processing operations here are the transaction processing that requires identity verification.

First, the electronic bookkeeping table 11 (refer to FIG. 2) performs the acceptance processing that accepts the slip data through operations of a customer or a sales office staff (step 81).

Next, the electronic bookkeeping table 11 may accept the data for identity verification. For example, in the case where the identity verification data is seal impression data, the seal scanner 13 (refer to FIG. 2) accepts the seal impression data (step 82).

Subsequently, the sales office staff checks the accepted identity verification data against the identity verification data registered in a master DB (step 83). The master DB is stored in the hard disk device, etc. of the center side system. In the case of the exemplary embodiment, identity verification is carried out by the staff on the sales office side.

Upon completion of the identity verification, the sales office side system 10A generates transaction data (step 84). The transaction data includes the slip data. The transaction data may include the identity verification data.

When the transaction data is generated, the sales office side system 10A starts the account processing as a system (step 85).

In the case of the exemplary embodiment, after the transaction data is generated, the sales office side system 10A executes the account processing in accordance with the instructions of the staff on the sales office side. In addition, the sales office side system 10A incorporates the execution record of the account processing into the transaction data (step 86).

Subsequently, the sales office side system 10A executes the medium processing, and incorporates the execution record of the medium processing into the transaction data (step 87). In this step, the corresponding amount of cash is paid to the customer from the medium processing device 16 (refer to FIG. 2), or the corresponding amount of cash is stored in the medium processing device 16.

In the exemplary embodiment, the sales office side system 10A provides a time stamp to the transaction data, subject to confirmation of execution of both steps 86 and 87 (step 17). Specifically, the sales office side system 10A generates a hash value of the transaction data, into which the execution record has been incorporated, transmits thereof to the time certificate authority 50 (refer to FIG. 15), and accepts a time-stamped hash value reply.

When the time stamp is provided, the sales office side system 10A generates customer record data (step 89) to output a receipt (step 90).

Note that, upon outputting the receipt, the sales office side system 10A terminates the account processing as a system.

In the exemplary embodiment, in the case where digitized slip data is stored instead of paper slip, even if alteration of the slip data is found, since the slip data at the time of the procedures in the sales office is provided with a time stamp, it is possible to make temporal distinction from subsequent alteration.

### Other Exemplary Embodiments

So far, the exemplary embodiments of the present disclosure have been described, but the technical scope of the present disclosure is not limited to the scope of the above-described exemplary embodiments. From the description of the claims, it is apparent that various modifications or improvements added to the above-described exemplary embodiments are also included in the technical scope of the present disclosure.

For example, in the above-described exemplary embodiments, the identity verification is performed using the seal impression data registered with the financial institution; however, the identity verification may be performed using a PIN code or a password linked to the account number, and a face image linked to the account number. The face image is an example of biological data.

In addition, in the above-described exemplary embodiments, the time stamps are provided to the slip data and the seal impression data, which are part of the transaction data; however, the time stamps may be provided only to the slip data or part of the slip data. Moreover, the target for providing the time stamp may include data of the sales office involved in the transaction and data of the sales office staff

In addition, in the above-described exemplary embodiment, the time stamp is provided at the time when the transaction management server 30 (refer to FIG. 1) receives the slip data from the sales office side system 10 (refer to FIG. 1); however, for example, as for the storage of cash, the time stamp may be provided at the step of notifying the center side system 20 (refer to FIG. 1) of completion of the storage. The same is true for other exemplary embodiments.

### REFERENCE SIGNS LIST

1, 1A, 1B, 1C, 1D Medium transaction system
10, 10A Sales office side system
11 Electronic bookkeeping table
12 Number ticketing machine
13 Seal scanner
14 Document scanner
15 Progress management tablet
16 Medium processing device
17, 21 Operator terminal
20, 20A Center side system
22 Host
23 Network
30 Transaction management server
31, 41 Control circuitry
31A Time stamp providing part
32, 42 Hard disk device
33, 43 Communication circuitry
40, 40A Customer DB server
41A Customer determination part
41B Processing order change management part
42A Customer DB
50 Time certificate authority

1. A transaction system executing a transaction with a customer by cooperation of a first terminal disposed in a sales office of a financial institution and a second terminal disposed in a location different from the sales office, wherein
the first terminal executes first processing related to the transaction and transmits data related to the transaction to the second terminal by communication,
the second terminal executes second processing related to the transaction, and
the transaction system further comprises a providing circuitry that provides a time stamp to at least part of the data related to the transaction before the second processing is started.

2. The transaction system according to claim 1, wherein
the first processing does not involve communication with an accounting system, and
the second processing involves communication with the accounting system.

3. The transaction system according to claim 1, wherein the transaction involves identity verification.

4. The transaction system according to claim 1, wherein the data related to the transaction is slip data.

5. The transaction system according to claim 1, wherein an execution record of the second processing is linked to the data related to the transaction, the data having been provided with the time stamp.

6. The transaction system according to claim 1, further comprising:
a medium processing device disposed in the sales office to execute medium processing, wherein
the medium processing includes at least one of taking-in processing and paying-out processing of a medium related to the transaction, and
the medium processing device communicates with the second terminal along with execution of the medium processing.

7. The transaction system according to claim 6, wherein the medium processing device notifies the second terminal of a result of the taking-in processing.

8. The transaction system according to claim 6, wherein the medium processing device executes the paying-out processing based on notification of a result of the second processing from the second terminal.

9. The transaction system according to claim 6, wherein an execution record of the medium processing by the medium processing device is linked to the data related to the transaction, the data having been provided with the time stamp.

10. The transaction system according to claim 1, wherein, if the customer satisfies a predetermined condition, an order of execution of the second processing is changed.

11. The transaction system according to claim 1, wherein, if the customer satisfies a predetermined condition, the first terminal provides data, which indicates that an order of execution of the transaction processing in the second terminal needs to be changed, to the data related to the transaction.

12. A transaction method executed by a transaction system executing a transaction with a customer by cooperation of a first terminal disposed in a sales office of a financial institution and a second terminal disposed in a location different from the sales office,
the transaction method comprises:
executing first processing related to the transaction and transmits data related to the transaction at the first terminal;
transmitting data related to the transaction to the second terminal;
executing second processing related to the transaction at the second terminal; and
providing a time stamp to at least part of the data related to the transaction before the second processing is started.

13. A device relaying communication between a first terminal disposed in a sales office of a financial institution to execute first processing related to a transaction with a customer and a second terminal disposed in a location different from the sales office to receive data related to the transaction from the first terminal and execute second processing related to the transaction, the device provides a time stamp to at least part of the data related to the transaction before the second processing is started.
